(19) United States
(12) Patent Application Publication
(10) Pub. No.: US 2021/0098180 A1
(43) Pub. Date: Apr. 1, 2021

(54) INDUCTOR STRUCTURE

(71) Applicant: Advanced Semiconductor Engineering, Inc., Kaohsiung (TW)

(72) Inventor: Wen-Long LU, Kaohsiung (TW)

(73) Assignee: Advanced Semiconductor Engineering, Inc., Kaohsiung (TW)

(21) Appl. No.: 16/588,655

(22) Filed: Sep. 30, 2019

(51) Int. Cl. H01F 27/28

(52) U.S. Cl. CPC H01F 27/2804; H01F 2027/2809

(57) ABSTRACT

An inductor structure includes a carrier, a coil structure, an isolation structure and a ferromagnetism structure. The carrier has an upper surface. The coil structure is disposed adjacent to the upper surface of the carrier. The isolation structure covers the upper surface and the coil structure. The ferromagnetism structure is disposed on the isolation structure.

### BACKGROUND

### 1. Field of the Disclosure

The present disclosure relates to an inductor structure, and to an inductor structure including a ferromagnetism structure.

### 2. Description of the Related Art

To improve the inductance value of an inductor, a complex glass substrate is often used as a base to form the inductor. This is due to the glass material has high dielectric coefficient. In the fabrication of the inductor, at least two drilling processes are performed to form via on the complex glass substrate.

That is, the complex glass substrate is difficult to process and may confront shift issues during drilling processes. In addition, the complex glass substrate has poor electrical characteristics, resulting in limited inductance performance of the inductor. In addition, the comparative inductor structures are too thick to meet the demands of thinner products.

### SUMMARY

In some embodiments, an inductor structure includes a carrier, a coil structure, an isolation structure and a ferromagnetism structure. The carrier has an upper surface. The coil structure is disposed adjacent to the upper surface of the carrier. The isolation structure covers the upper surface and the coil structure. The ferromagnetism structure is disposed on the isolation structure.

In some embodiments, an inductor structure includes a base, an isolation structure, a coil structure and at least a ferromagnetism structure. The base has an upper surface. The isolation structure is disposed adjacent to the upper surface of the base. The coil structure is embedded in the isolation structure. The ferromagnetism structure is disposed around a portion of the coil structure.

### BRIEF DESCRIPTION OF THE DRAWINGS

Aspects of some embodiments of the present disclosure are readily understood from the following detailed description when read with the accompanying figures. It is noted that various structures may not be drawn to scale, and dimensions of the various structures may be arbitrarily increased or reduced for clarity of discussion.

FIG. 1 illustrates a cross-sectional view of an inductor structure according to some embodiments of the present disclosure.

FIG. 2 illustrates a schematic view of a configuration of a coil structure and a ferromagnetism structure of an inductor structure according to some embodiments of the present disclosure.

FIG. 3 illustrates a cross-sectional view of an inductor structure according to some embodiments of the present disclosure.

FIG. 4 illustrates a cross-sectional view of an inductor structure according to some embodiments of the present disclosure.

FIG. 5 illustrates a cross-sectional view of an inductor structure according to some embodiments of the present disclosure.

FIG. 6 illustrates a schematic view of a configuration of a coil structure and a ferromagnetism structure of an inductor structure according to some embodiments of the present disclosure.

FIG. 7 illustrates a cross-sectional view of an inductor structure according to some embodiments of the present disclosure.

FIG. 8 illustrates a cross-sectional view of an inductor structure according to some embodiments of the present disclosure.

FIG. 9 illustrates a cross-sectional view of an inductor structure according to some embodiments of the present disclosure.

FIG. 10 illustrates a cross-sectional view of an inductor structure according to some embodiments of the present disclosure.

FIG. 11 illustrates a schematic view of a configuration of a coil structure and a ferromagnetism structure of an inductor structure according to some embodiments of the present disclosure.

FIG. 12 illustrates a cross-sectional view of an inductor structure according to some embodiments of the present disclosure.

FIG. 13 illustrates a cross-sectional view of an inductor structure according to some embodiments of the present disclosure.

FIG. 14 illustrates one or more stages of an example of a method for manufacturing an inductor structure according to some embodiments of the present disclosure.

FIG. 15 illustrates one or more stages of an example of a method for manufacturing an inductor structure according to some embodiments of the present disclosure.

FIG. 16 illustrates one or more stages of an example of a method for manufacturing an inductor structure according to some embodiments of the present disclosure.

FIG. 17 illustrates one or more stages of an example of a method for manufacturing an inductor structure according to some embodiments of the present disclosure.

FIG. 18 illustrates one or more stages of an example of a method for manufacturing an inductor structure according to some embodiments of the present disclosure.

FIG. 19 illustrates one or more stages of an example of a method for manufacturing an inductor structure according to some embodiments of the present disclosure.

FIG. 20 illustrates one or more stages of an example of a method for manufacturing an inductor structure according to some embodiments of the present disclosure.

FIG. 21 illustrates one or more stages of an example of a method for manufacturing an inductor structure according to some embodiments of the present disclosure.

FIG. 22 illustrates one or more stages of an example of a method for manufacturing an inductor structure according to some embodiments of the present disclosure.

FIG. 23 illustrates one or more stages of an example of a method for manufacturing an inductor structure according to some embodiments of the present disclosure.

FIG. 24 illustrates one or more stages of an example of a method for manufacturing an inductor structure according to some embodiments of the present disclosure.

FIG. 25 illustrates one or more stages of an example of a method for manufacturing an inductor structure according to some embodiments of the present disclosure.

FIG. 26 illustrates one or more stages of an example of a method for manufacturing an inductor structure according to some embodiments of the present disclosure.

FIG. 27 illustrates one or more stages of an example of a method for manufacturing an inductor structure according to some embodiments of the present disclosure.

FIG. 28 illustrates one or more stages of an example of a method for manufacturing an inductor structure according to some embodiments of the present disclosure.

FIG. 29 illustrates one or more stages of an example of a method for manufacturing an inductor structure according to some embodiments of the present disclosure.

FIG. 30 illustrates one or more stages of an example of a method for manufacturing an inductor structure according to some embodiments of the present disclosure.

FIG. 31 illustrates one or more stages of an example of a method for manufacturing an inductor structure according to some embodiments of the present disclosure.

FIG. 32 illustrates one or more stages of an example of a method for manufacturing an inductor structure according to some embodiments of the present disclosure.

FIG. 33 illustrates one or more stages of an example of a method for manufacturing an inductor structure according to some embodiments of the present disclosure.

FIG. 34 illustrates one or more stages of an example of a method for manufacturing an inductor structure according to some embodiments of the present disclosure.

FIG. 35 illustrates one or more stages of an example of a method for manufacturing an inductor structure according to some embodiments of the present disclosure.

FIG. 36 illustrates one or more stages of an example of a method for manufacturing an inductor structure according to some embodiments of the present disclosure.

FIG. 37 illustrates one or more stages of an example of a method for manufacturing an inductor structure according to some embodiments of the present disclosure.

FIG. 38 illustrates one or more stages of an example of a method for manufacturing an inductor structure according to some embodiments of the present disclosure.

FIG. 39 illustrates one or more stages of an example of a method for manufacturing an inductor structure according to some embodiments of the present disclosure.

FIG. 40 illustrates one or more stages of an example of a method for manufacturing an inductor structure according to some embodiments of the present disclosure.

FIG. 41 illustrates one or more stages of an example of a method for manufacturing an inductor structure according to some embodiments of the present disclosure.

FIG. 42 illustrates one or more stages of an example of a method for manufacturing an inductor structure according to some embodiments of the present disclosure.

FIG. 43 illustrates one or more stages of an example of a method for manufacturing an inductor structure according to some embodiments of the present disclosure.

FIG. 44 illustrates one or more stages of an example of a method for manufacturing an inductor structure according to some embodiments of the present disclosure.

### DETAILED DESCRIPTION

Common reference numerals are used throughout the drawings and the detailed description to indicate the same or similar components. Embodiments of the present disclosure will be readily understood from the following detailed description taken in conjunction with the accompanying drawings.

The following disclosure provides many different embodiments, or examples, for implementing different features of the provided subject matter. Specific examples of components and arrangements are described below to explain certain aspects of the present disclosure. These are, of course, merely examples and are not intended to be limiting. For example, the formation of a first feature over or on a second feature in the description that follows may include embodiments in which the first and second features are formed or disposed in direct contact, and may also include embodiments in which additional features may be formed or disposed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

At least some embodiments of the present disclosure provide for an inductor structure which may improve inductance value and reduced thickness. In some embodiments, the inductor structure includes a ferromagnetism structure. At least some embodiments of the present disclosure further provide for techniques for manufacturing the inductor structure to reduce a total thickness of the inductor structure.

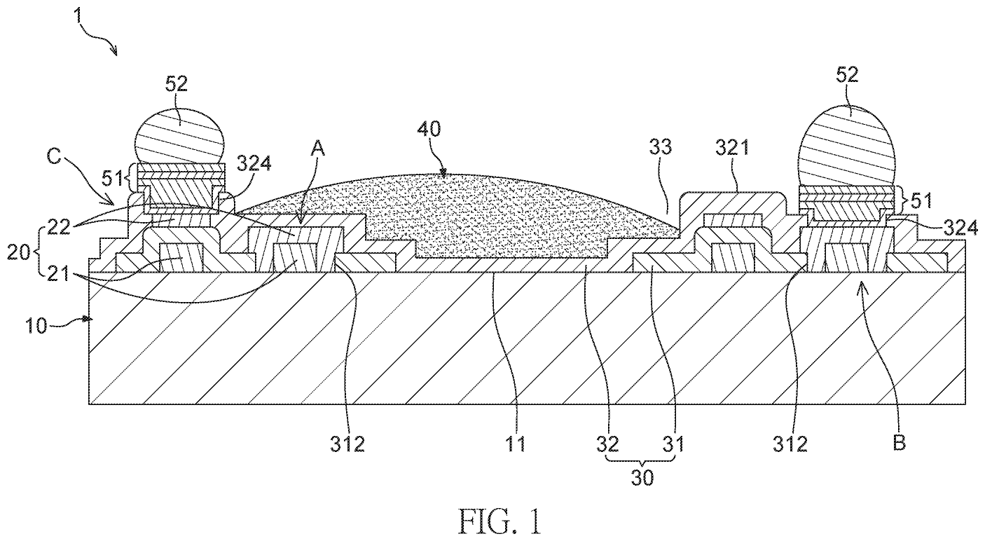

FIG. 1 illustrates a cross-sectional view of an inductor structure 1 according to some embodiments of the present disclosure. The inductor structure 1 includes a carrier 10, a coil structure 20, an isolation structure 30, a ferromagnetism structure 40, a plurality of bumps 51 and a plurality of external connectors 52. In some embodiments, the inductor structure 1 may be an inductor structure with planar spiral coils.

A material of the carrier 10 may be, for example, polyimide (PI), epoxy, FR4, SiO, SiN, ceramic, glass or sapphire. The carrier 10 has an upper surface 11. A thickness of the carrier 10 may be about 25 μm to about 100 μm.

The coil structure 20 is disposed adjacent to the upper surface 11 of the carrier 10. The coil structure 20 may be, for example, planar spiral coil. A material of the coil structure 20 may include, for example, graphene, Au, Ag, Cu, Al, Pt, Pd or alloy.

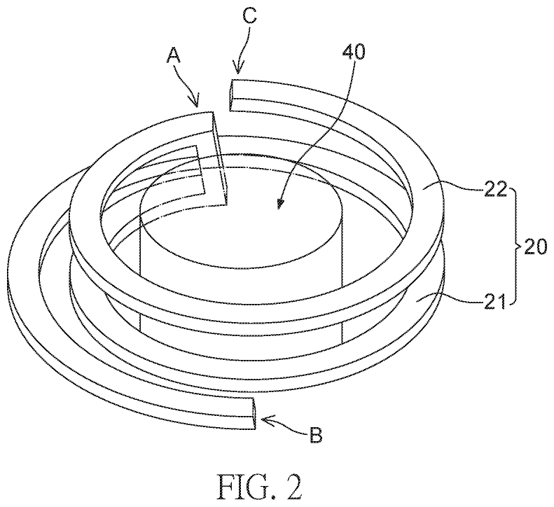

FIG. 2 illustrates a schematic view of a configuration of a coil structure 20 and a ferromagnetism structure 40 of an inductor structure 1 according to some embodiments of the present disclosure. Referring to FIG. 1 and FIG. 2, in some embodiments, the coil structure 20 may include a first coil layer 21 and a second coil layer 22. The first coil layer 21 is disposed on the upper surface 11 of the carrier 10. The first coil layer 21 may be in shape of spiral. A material of the first coil layer 21 may be graphene. A thickness of the first coil layer 21 may be about 1 nm to about 50 nm.

The second coil layer 22 is disposed above the first coil layer 21. In some embodiments, an end of the second coil layer 22 is connected to the first coil layer 21 at a position “A”. The second coil layer 22 may be in shape of spiral, e.g., the shape of the second coil layer 22 may be the same as the shape of the first coil layer 21. A material of the second coil layer 22 may be graphene. A thickness of the second coil layer 22 may be about 1 nm to about 50 nm.

The isolation structure 30 covers the upper surface 11 and the coil structure 20. A material of the isolation structure 30 may be, for example, polyimide (PI), epoxy, ajinomoto build-up film (ABF), polybenzoxazole (PBO), Ta₂O₅, SiO₂ or Si₃N₄. In some embodiments, the isolation structure 30 may include a first isolation layer 31 and a second isolation layer 32.

The first isolation layer 31 covers a portion (e.g., a portion of the first coil layer 21) of the coil structure 20. In some embodiments, a portion of the first isolation layer 31 may be disposed between the first coil layer 21 and the second coil layer 22 expect for at the position “A” and at a position “B”. A thickness of the first isolation layer 31 may be about 0.2 μm to about 0.8 μm.

The second isolation layer 32 covers the first isolation layer 31, a portion of the second coil layer 22 and a portion of the upper surface 11. In some embodiments, the second isolation layer 32 may define a plurality of openings 324 extending through the second isolation layer 32 at the position “B” and at a position “C” to expose a portion of the second coil layer 22. A thickness of the second isolation layer 32 may be about 0.2 μm to about 0.8 μm.

In some embodiments, the first isolation layer 31 may define a plurality of openings 312 extending through the first isolation layer 31 at the position “A” and at the position “B” to expose a portion of the first coil layer 21. A portion of the second coil layer 22 may extend into the openings 312 to cover a portion of the upper surface 11 and cover and contact the exposed portion of the first coil layer 21.

In some embodiments, the isolation structure 30 may define a cavity 33. The cavity 33 may be recessed from a top surface 321 of the second isolation layer 32.

The ferromagnetism structure 40 is disposed on the isolation structure 30. A material of the ferromagnetism structure 40 may be, for example, mumetal: 18K˜22K (relative magnetic permeability), permeable alloy: 6K˜10K (relative magnetic permeability), furnace steel: 3K˜5K (relative magnetic permeability), steel: 450˜800 (relative magnetic permeability), or Ni: 80˜120 (relative magnetic permeability). In some embodiments, one of the above materials may be mixed with binder, solvent and/or polymer filler to form the ferromagnetism structure 40. A thickness of the ferromagnetism structure 40 may be about 0.5 μm to about 5 μm.

In some embodiments, the ferromagnetism structure 40 may be disposed on the second isolation layer 32 of the isolation structure 30 and in the cavity 33. In addition, the coil structure 20 (including the first coil layer 21 and the second coil layer 22) may surround the ferromagnetism structure 40 to improve the inductance value to more than 0.01 mH and increase the inductance density to more than 2.3 mH/mm³.

The bumps 51 are electrically connected to the coil structure 20. In some embodiments, the bumps 51 may be disposed in the openings 324 of the second isolation layer 32 and electrically connected to the second coil layer 22 of the coil structure 20. In addition, each of the bumps 51 may include a metal layer or a plurality of metal layers stacked on one another.

The external connectors 52 are disposed on the bumps 51. The external connectors 52 may be, for example, solder ball or solder bump.

Due to the thickness of the carrier 10, the thickness of the coil structure 20, the thickness of the isolation structure 30, the thickness of the ferromagnetism structure 40, the thickness of the bump 51 and the thickness of the external connector 52 are greatly reduced, a whole thickness of the inductor structure 1 may be thinned to lower than 0.1 mm.

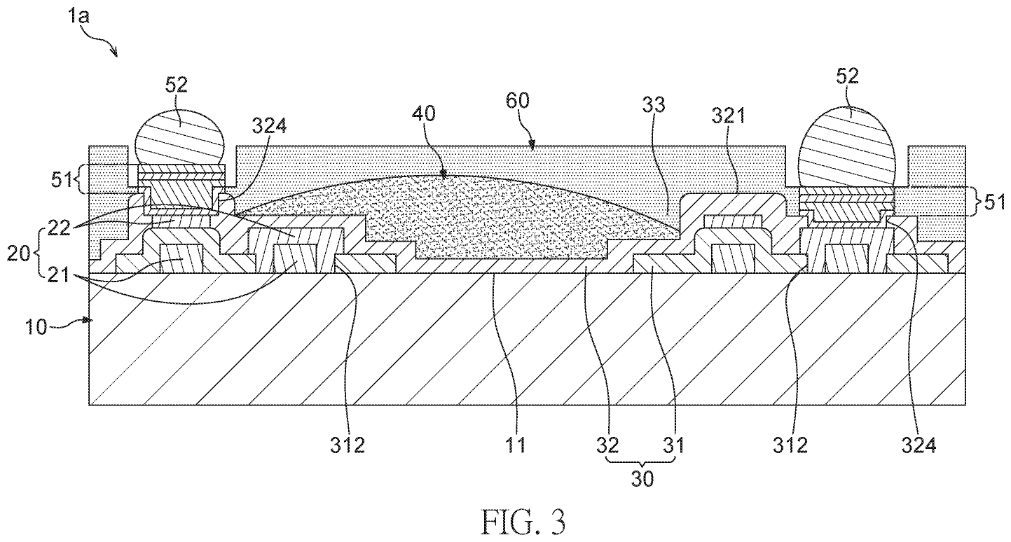

FIG. 3 illustrates a cross-sectional view of an inductor structure 1a according to some embodiments of the present disclosure. The inductor structure 1a is similar to the inductor structure 1 shown in FIG. 1 and FIG. 2, except that the inductor structure 1a further includes a protection layer 60. The protection layer 60 may cover the isolation structure 30 and the ferromagnetism structure 40 to protect the isolation structure 30 and the ferromagnetism structure 40. The protection layer 60 may be a passivation layer such as epoxy or polymer liquid or film. Alternatively, the protection layer 60 may be solder mask liquid or dry-film.

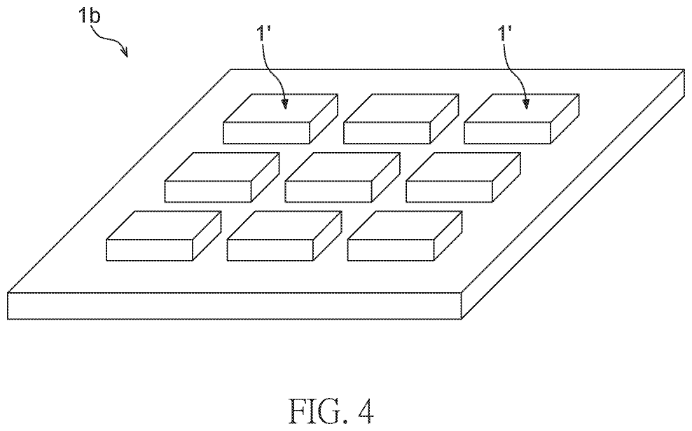

FIG. 4 illustrates a cross-sectional view of an inductor structure 1b according to some embodiments of the present disclosure. The inductor structure 1b is similar to the inductor structure 1 shown in FIG. 1 and FIG. 2, except that the inductor structure 1b further includes a plurality of inductor units 1′ disposed apart from each other. Each of the inductor units 1′ may include the structure as the inductor structure 1 shown in FIG. 1 and FIG. 2. In some embodiments, the inductor units 1′ may be formed concurrently.

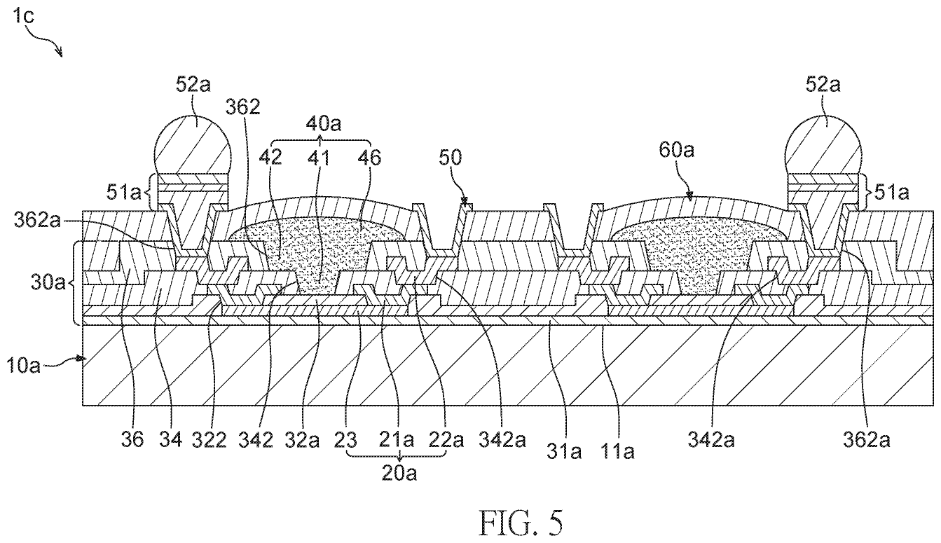

FIG. 5 illustrates a cross-sectional view of an inductor structure 1c according to some embodiments of the present disclosure. The inductor structure 1c is similar to the inductor structure 1 shown in FIG. 1 and FIG. 2, except for the configurations of the coil structure 20a, the isolation structure 30a and the ferromagnetism structure 40a. The inductor structure 1c includes a base 10a, the coil structure 20a, the isolation structure 30a, at least a ferromagnetism structure 40a, at least one via structure 50, a plurality of bumps 51a, a plurality of external connectors 52a and a protection layer 60a. In some embodiments, the inductor structure 1c may be an inductor structure with vertical spiral coils.

A material of the base 10a may be, for example, polyimide (PI), epoxy, ajinomoto build-up film (ABF), polybenzoxazole (PBO), Ta₂O₅, SiO₂, Si₃N₄, glass or ceramic. The base 10a has an upper surface 11a. A thickness of the base 10a may be about 20 μm to about 100 μm.

The isolation structure 30a is disposed adjacent to the upper surface 11a of the base 10a. A material of the isolation structure 30a may be, for example, polyimide (PI), epoxy, ajinomoto build-up film (ABF), polybenzoxazole (PBO), Ta₂O₅, SiO₂ or Si₃N₄. In some embodiments, the isolation structure 30a may include a first isolation layer 31a, a second isolation layer 32a, a third isolation layer 34 and a fourth isolation layer 36.

The first isolation layer 31a covers the upper surface 11a of the base 10a. A thickness of the first isolation layer 31a may be about 0.2 μm to about 0.5 μm.

The second isolation layer 32a is disposed on the first isolation layer 31a. A thickness of the second isolation layer 32a may be about 0.2 μm to about 0.5 μm. In some embodiments, the second isolation layer 32a may define a plurality of openings 322 extending through the second isolation layer 32a to expose a portion of the first isolation layer 31a.

The third isolation layer 34 is disposed on the second isolation layer 32a. A thickness of the third isolation layer 34 may be about 0.2 μm to about 0.5 μm. In some embodiments, the third isolation layer 34 may define a plurality of openings 342, 342a extending through the third isolation layer 34 to expose a portion of the second isolation layer 32a (e.g., the openings 342) and a portion of the first coil layer 21a (e.g., the openings 342a).

The fourth isolation layer 36 is disposed on the third isolation layer 34. A thickness of the fourth isolation layer 36 may be about 0.2 μm to about 0.5 μm. In some embodiments, the fourth isolation layer 36 may define a plurality of openings 362, 362a extending through the fourth isolation layer 36 to expose a portion of the third isolation layer 34 (e.g., the openings 362) and a portion of the second coil layer 22a (e.g., the openings 362a). The opening 362 of the fourth isolation layer 36 may communicate with the opening 342 of the third isolation layer 34. In some embodiments, a size of the opening 362 may be greater than a size of the opening 342.

The coil structure 20a is embedded in the isolation structure 30a. The coil structure 20a may be, for example, vertical spiral coil. A material of the coil structure 20a may include, for example, graphene, Au, Ag, Cu, Al, Ni or alloy.

In some embodiments, the coil structure 20a may include at least one inner electrode 23, a first coil layer 21a and at least a second coil layer 22a. The inner electrode 23 is disposed on the first isolation layer 31a of the isolation structure 30a and covered by the second isolation layer 32a. A material of the inner electrode 23 may be graphene. A thickness of the inner electrode 23 may be about 1 nm to about 5 nm.

The first coil layer 21a is disposed on the second isolation layer 32a and covered by the third isolation layer 34. A portion of the first coil layer 21a extends through the second isolation layer 32a and is electrically connected to the inner electrode 23. A material of the first coil layer 21a may be graphene. A thickness of the first coil layer 21a may be about 1 nm to about 5 nm.

The second coil layer 22a is disposed on the third isolation layer 34 and covered by the fourth isolation layer 36. A portion of the second coil layer 22a is disposed on and electrically connected to the first coil layer 21a. A material of the second coil layer 22a may be graphene. A thickness of the second coil layer 22a may be about 1 nm to about 5 nm.

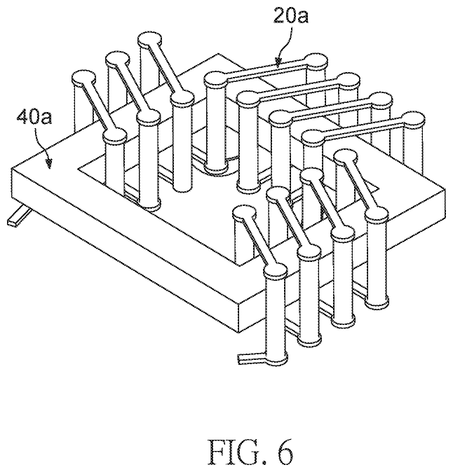

FIG. 6 illustrates a schematic view of a configuration of a coil structure 20a and a ferromagnetism structure 40a of an inductor structure 1c according to some embodiments of the present disclosure. Referring to FIG. 5 and FIG. 6, the coil structure 20a surrounds the ferromagnetism structure 40a to improve the inductance value to more than 0.01 mH and increase the inductance density to more than 2.3 mH/mm³. A material of the ferromagnetism structure 40a may be, for example, mumetal: 18K˜22K (relative magnetic permeability), permeable alloy: 6K˜10K (relative magnetic permeability), furnace steel: 3K˜5K (relative magnetic permeability), steel: 450˜800 (relative magnetic permeability), or Ni: 80˜120 (relative magnetic permeability). In some embodiments, one of the above materials may be mixed with binder, solvent and/or polymer filler to form the ferromagnetism structure 40a.

In some embodiments, the ferromagnetism structure 40a may correspond to the inner electrode 23 of the coil structure 20a, and a portion of the second isolation layer 32a may be disposed between the ferromagnetism structure 40a and the inner electrode 23.

In some embodiments, the ferromagnetism structure 40a may have a cross-section in a mushrooms-shape. The ferromagnetism structure 40a may include a first taper portion 41, a second taper portion 42 and a protruding portion 46. The first taper portion 41 may be disposed on the exposed portion of the second isolation layer 32a and in the opening 342 of the third isolation layer 34. In some embodiments, the first taper portion 41 may extend through the third isolation layer 34. In addition, the first taper portion 41 may taper downward.

The second taper portion 42 may be disposed on and connected to the first taper portion 41. In some embodiments, the second taper portion 42 may be disposed in the opening 362 of the fourth isolation layer 36. In some embodiments, the second taper portion 42 may extend through the fourth isolation layer 36. In addition, the second taper portion 42 may taper downward.

The protruding portion 46 may be disposed on and connected to the second taper portion 42. In some embodiments, the protruding portion 46 may also be disposed on a top surface of the fourth isolation layer 36.

The via structure 50 is electrically connected to the coil structure 20a. In some embodiments, the via structure 50 may be disposed in the opening 362a of the fourth isolation layer 36 and an opening of the protection layer 60a, and electrically connected to the second coil layer 22a of the coil structure 20a.

The bumps 51a are disposed on the via structure 50, and electrically connected to the coil structure 20a. In some embodiments, the bumps 51a may be electrically connected to the second coil layer 22a of the coil structure 20a. In addition, each of the bumps 51a may include a metal layer or a plurality of metal layers stacked on one another.

The external connectors 52a are disposed on the bumps 51a. The external connectors 52a may be, for example, solder ball or solder bump.

The protection layer 60a covers the isolation structure 30a and the ferromagnetism structure 40a to protect the isolation structure 30a and the ferromagnetism structure 40a.

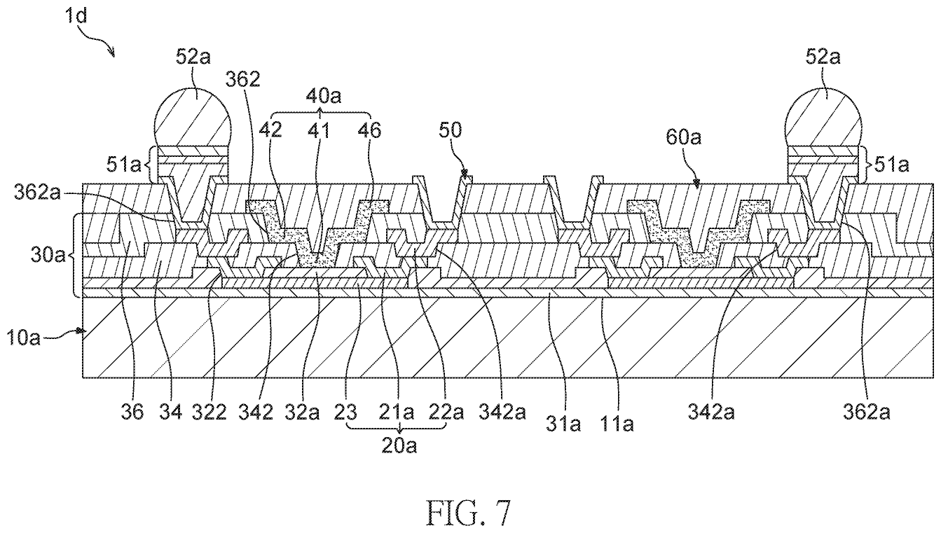

FIG. 7 illustrates a cross-sectional view of an inductor structure 1d according to some embodiments of the present disclosure. The inductor structure 1d is similar to the inductor structure 1c shown in FIG. 5 and FIG. 6, except that the shape of the ferromagnetism structure 40a. In some embodiments, the ferromagnetism structure 40a may have a cross-section in a V-shape.

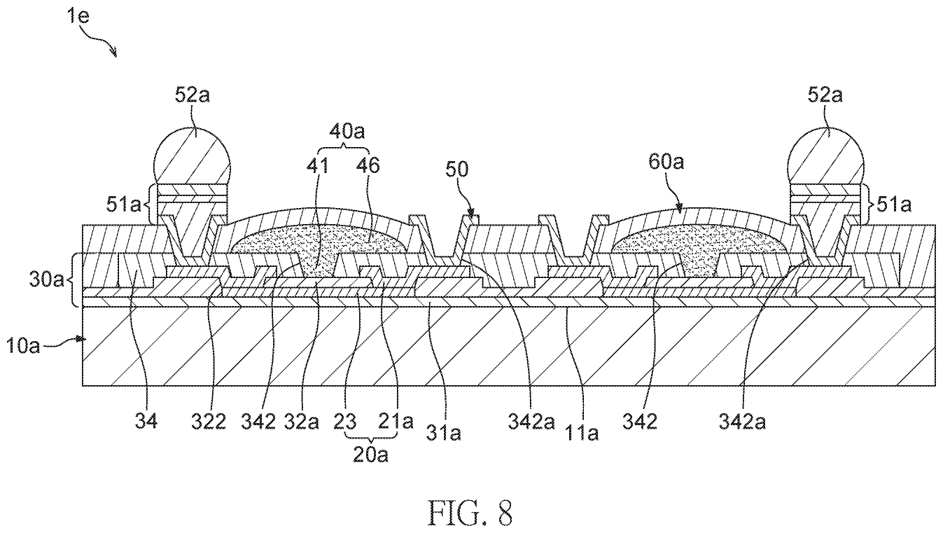

FIG. 8 illustrates a cross-sectional view of an inductor structure 1e according to some embodiments of the present disclosure. The inductor structure 1e is similar to the inductor structure 1c shown in FIG. 5 and FIG. 6, except that the second coil layer 22a of the coil structure 20a, the fourth isolation layer 36 of the isolation structure 30a and the second taper portion 42 of the ferromagnetism structure 40a are omitted. In some embodiments, the protruding portion 46 may be disposed on and connected to the first taper portion 41.

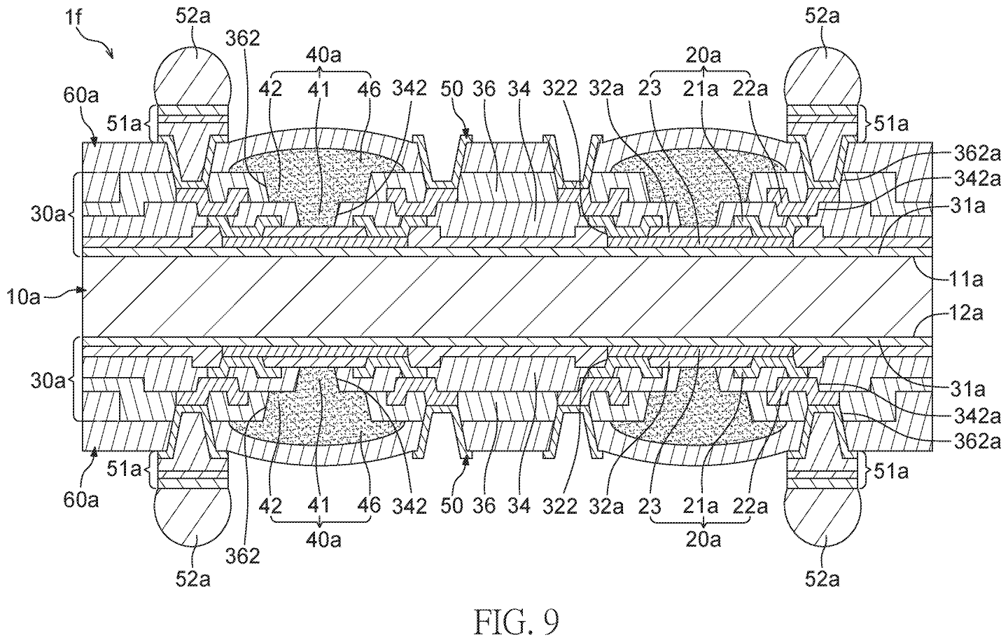

FIG. 9 illustrates a cross-sectional view of an inductor structure if according to some embodiments of the present disclosure. The inductor structure if is similar to the inductor structure 1c shown in FIG. 5 and FIG. 6, except that the inductor structure if is an upper and lower symmetrical structure. That is, the coil structure 20a, the isolation structure 30a, the ferromagnetism structure 40a, the via structure 50, the bumps 51a and the external connectors 52a may be formed on the upper surface 11a and a lower surface 12a of the base 10a.

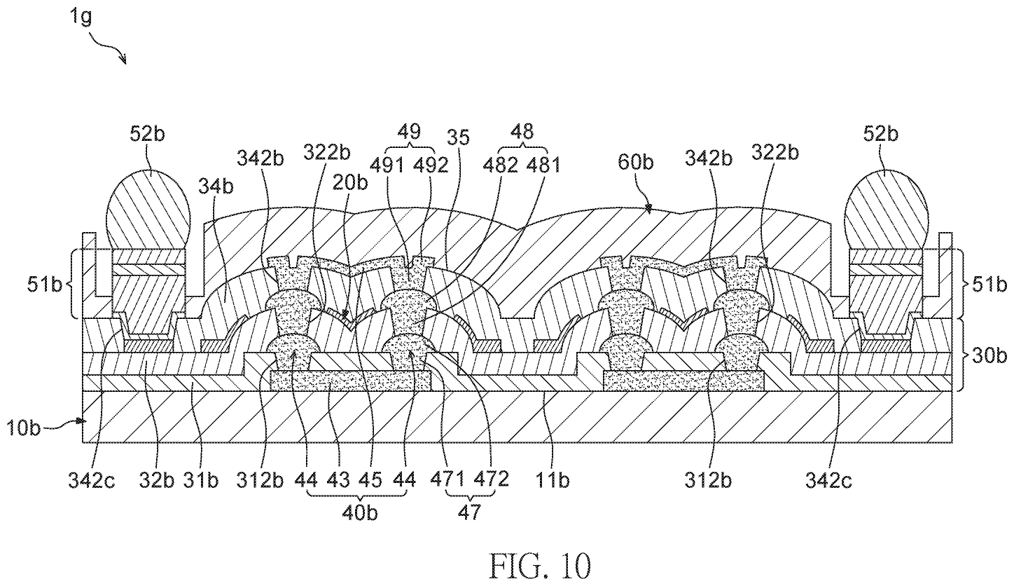

FIG. 10 illustrates a cross-sectional view of an inductor structure 1g according to some embodiments of the present disclosure. The inductor structure 1g is similar to the inductor structure 1c shown in FIG. 5 and FIG. 6, except for the structures of the coil structure 20b, the isolation structure 30b and the ferromagnetism structure 40b. The inductor structure 1g includes a base 10b, the coil structure 20b, the isolation structure 30b, at least a ferromagnetism structure 40b, a plurality of bumps 51b, a plurality of external connectors 52b and a protection layer 60b. In some embodiments, the inductor structure 1g may be a flexible inductor structure.

A material of the base 10b may be, for example, polyimide (PI), epoxy, ajinomoto build-up film (ABF), polybenzoxazole (PBO), Ta₂O₅, SiO₂, Si₃N₄, glass or ceramic. The base 10b has an upper surface 11b. A thickness of the base 10b may be about 5 μm to about 50 μm.

The isolation structure 30b is disposed adjacent to the upper surface 11b of the base 10a. A material of the isolation structure 30b may be, for example, polyimide (PI), epoxy, ajinomoto build-up film (ABF), polybenzoxazole (PBO), Ta₂O₅, SiO₂ or Si₃N₄. In some embodiments, the isolation structure 30b may include a first isolation layer 31b, a second isolation layer 32b and a third isolation layer 34b.

The first isolation layer 31b covers a portion of the upper surface 11b of the base 10b. A thickness of the first isolation layer 31b may be about 0.2 μm to about 0.5 μm. In some embodiments, the first isolation layer 31b may define a plurality of openings 312b extending through the first isolation layer 31b.

The second isolation layer 32b is disposed on the first isolation layer 31b. A thickness of the second isolation layer 32b may be about 0.2 μm to about 0.5 μm. In some embodiments, the second isolation layer 32b may define a plurality of openings 322b extending through the second isolation layer 32b and corresponding to the openings 312b of the first isolation layer 31b.

The third isolation layer 34b is disposed on the second isolation layer 32a. A thickness of the third isolation layer 34b may be about 0.2 μm to about 0.5 μm. In some embodiments, the third isolation layer 34b may define a plurality of openings 342b, 342c extending through the third isolation layer 34b and corresponding to the openings 322b of the second isolation layer 32b.

The coil structure 20b is embedded in the isolation structure 30b. The coil structure 20b may be, for example, series coil. A material of the coil structure 20b may include, for example, graphene, Au, Ag, Cu, Al, Ni or alloy. In some embodiments, the coil structure 20b may be disposed on the second isolation layer 32b of the isolation structure 30b. A thickness of the coil structure 20b may be about 1 nm to about 5 nm.

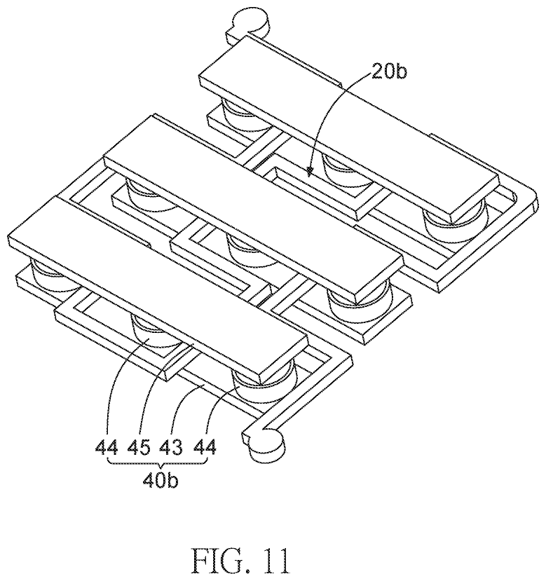

FIG. 11 illustrates a schematic view of a configuration of a coil structure 20b and a ferromagnetism structure 40b of an inductor structure 1g according to some embodiments of the present disclosure. Referring to FIG. 10 and FIG. 11, the ferromagnetism structure 40b is disposed around a portion of the coil structure 20b to improve the inductance value to more than 0.01 mH and increase the inductance density to more than 2.3 mH/mm³. A material of the ferromagnetism structure 40b may be, for example, NdFeB, SmCo₅ or Sm₂Co₁₇.

In some embodiments, the ferromagnetism structure 40b may have a cross-section in a square-shape. The ferromagnetism structure 40b may include a lower portion 43, a plurality of via portions 44 and an upper portion 45. The lower portion 43 may be disposed on the upper surface 11b of the base 10b. In some embodiments, the isolation structure 30b (e.g., the first isolation layer 31b) may cover a portion of the lower portion 43. In addition, the openings 312b of the first isolation layer 31b may expose a portion of the lower portion 43.

The via portions 44 may extend through the isolation structure 30b and be connected to the lower portion 43. In some embodiments, the portion of the coil structure 20b may be disposed between the via portions 44.

In some embodiments, each of the via portions 44 may include a first via 47, a second via 48 and a third via 49. The first via 47 may extend through the first isolation layer 31b and be disposed on the lower portion 43. In some embodiments, the first via 47 may be in a mushrooms-shape. The first via 47 may include a taper portion 471 and a protruding portion 472. The taper portion 471 may be disposed in the opening 312b of the first isolation layer 31b and on the exposed portion of the lower portion 43. In some embodiments, the taper portion 471 may taper downward. The protruding portion 472 may be disposed on the first isolation layer 31b and connected to the taper portion 471. In some embodiments, the protruding portion 472 may be in a curved-shape.

The second via 48 may be disposed on and connected to the first via 47. The second via 48 may extend through the second isolation layer 32b. In some embodiments, the second via 48 may be in a mushrooms-shape. The second via 48 may include a taper portion 481 and a protruding portion 482. The taper portion 481 may be disposed in the opening 322b of the second isolation layer 32b and on the protruding portion 472 of the first via 47. In some embodiments, the taper portion 481 may taper downward. The protruding portion 482 may be disposed on the second isolation layer 32b and connected to the taper portion 481. In some embodiments, the protruding portion 482 may be in a curved-shape.

The third via 49 may be disposed on and connected to the second via 48. The third via 49 may extend through the third isolation layer 34b. In some embodiments, the third via 49 may be in a mushrooms-shape. The third via 49 may include a taper portion 491 and a protruding portion 492. The taper portion 491 may be disposed in the opening 342b of the third isolation layer 34b and on the protruding portion 482 of the second via 48. In some embodiments, the taper portion 491 may taper downward. The protruding portion 492 may be disposed on the third isolation layer 34b and connected to the taper portion 491. In some embodiments, the protruding portion 492 may be in a curved-shape.

The upper portion 45 may be disposed on the isolation structure 30b and connected to the via portions 44. In some embodiments, the upper portion 45 may be disposed on the third isolation layer 34b of the isolation structure 30b and connected to the third vias 49 of the via portions 44. In some embodiments, the isolation structure 30b may have a curved surface 35 (e.g., a top surface of the third isolation layer 34b), and the upper portion 45 may be disposed on the curved surface 35 of the isolation structure 30b.

In some embodiments, the lower portion 43, the via portions 44 and the upper portion 45 may constitute a ferromagnetism structure loop.

The bumps 51b are disposed in the openings 342c of the third isolation layer 34b and electrically connected to the coil structure 20b. In some embodiments, each of the bumps 51b may include a metal layer or a plurality of metal layers stacked on one another.

The external connectors 52b are disposed on the bumps 51b. The external connectors 52b may be, for example, solder ball or solder bump.

The protection layer 60b covers the isolation structure 30b and the ferromagnetism structure 40b to protect the isolation structure 30b and the ferromagnetism structure 40b.

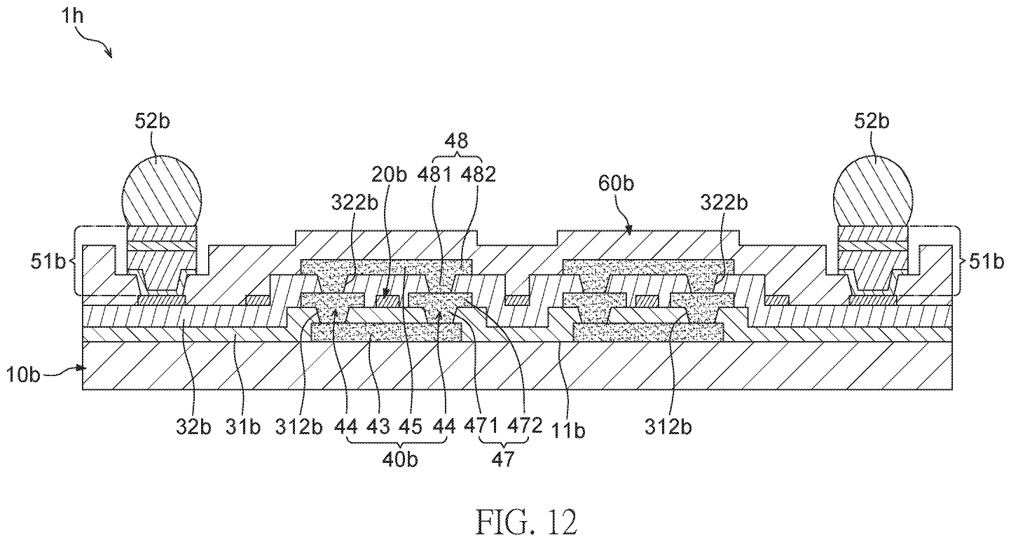

FIG. 12 illustrates a cross-sectional view of an inductor structure 1h according to some embodiments of the present disclosure. The inductor structure 1h is similar to the inductor structure 1g shown in FIG. 10 and FIG. 11, except that the shape of the ferromagnetism structure 40b, and the third isolation layer 34b of the isolation structure 30b and the third vias 49 of the via portions 44 are omitted. In some embodiments, the protruding portion 472 of the first via 47 and the protruding portion 482 of the second via 48 may be in a level-shape. In addition, the upper portion 45 may be disposed on the second isolation layer 32b of the isolation structure 30b and connected to the second vias 48 of the via portions 44.

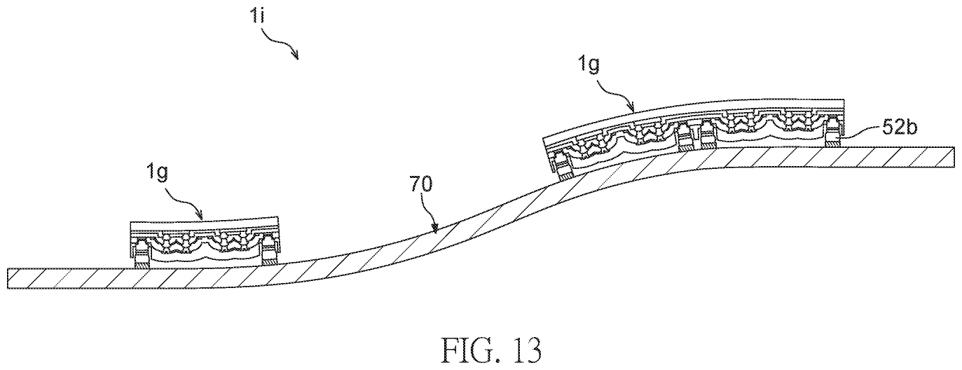

FIG. 13 illustrates a cross-sectional view of an inductor structure 1i according to some embodiments of the present disclosure. The inductor structure 1i is similar to the inductor structure 1g shown in FIG. 10 and FIG. 11, except that the inductor structure 1i further includes a flexible substrate 70. In some embodiments, the external connectors 52b may be electrically connected to the flexible substrate 70.

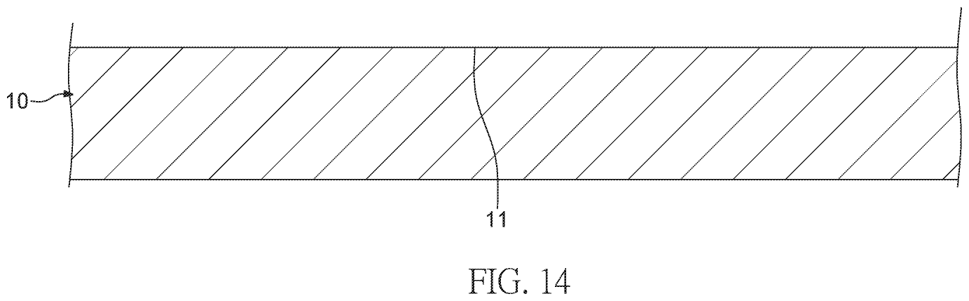

FIG. 14 through FIG. 20 illustrate a method for manufacturing an inductor structure according to some embodiments of the present disclosure. In some embodiments, the method is for manufacturing an inductor structure such as the inductor structure 1 shown in FIG. 1.

Referring to FIG. 14, a carrier 10 is provided. A material of the carrier 10 may be, for example, polyimide (PI), epoxy, FR4, SiO, SiN, ceramic, glass or sapphire. The carrier 10 has an upper surface 11. A thickness of the carrier 10 may be about 25 μm to about 100 μm.

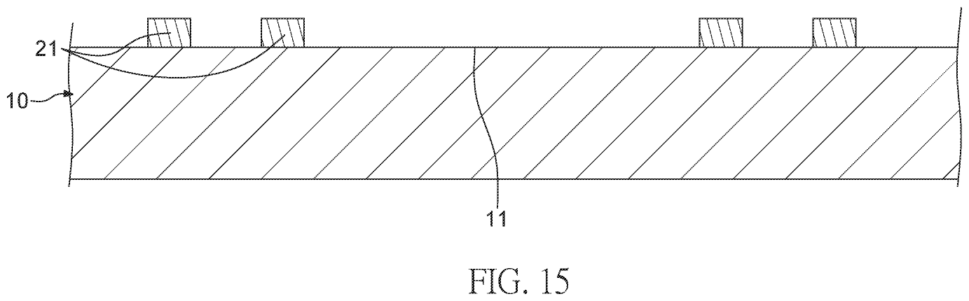

Referring to FIG. 15 through FIG. 17, a coil structure 20 is formed on the upper surface 11 of the carrier 10. Referring to FIG. 15, a first coil layer 21 is formed on the upper surface 11 of the carrier 10. The first coil layer 21 may be in shape of spiral. A material of the first coil layer 21 may be graphene. A thickness of the first coil layer 21 may be about 1 nm to about 50 nm.

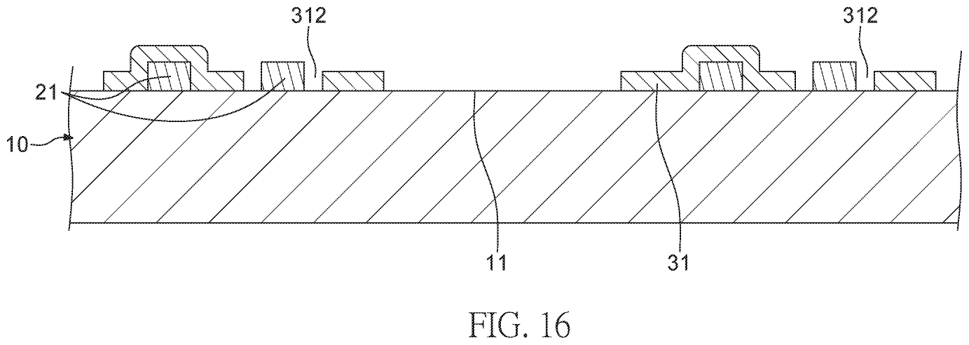

Referring to FIG. 16, a first isolation layer 31 is formed on the upper surface 11 of the carrier 10 to cover a portion of the first coil layer 21. In some embodiments, a plurality of openings 312 are formed to extend through the first isolation layer 31 to expose a portion of the first coil layer 21 by, for example, photolithography process (e.g., including exposure and development). A material of the first isolation layer 31 may be, for example, polyimide (PI), epoxy, ajinomoto build-up film (ABF), polybenzoxazole (PBO), Ta₂O₅, SiO₂ or Si₃N₄. A thickness of the first isolation layer 31 may be about 0.2 μm to about 0.8 μm.

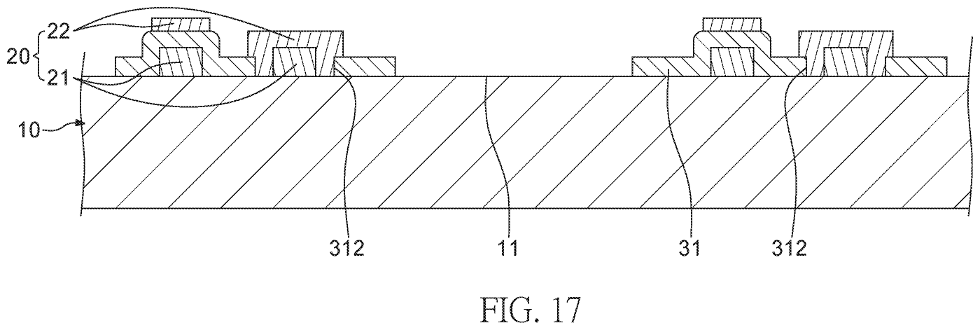

Referring to FIG. 17, a second coil layer 22 is formed on the first isolation layer 31 and the first coil layer 21 to cover a portion of the first isolation layer 31 and a portion of the first coil layer 21. Thus, the first coil layer 21 and the second coil layer 22 may constitute the coil structure 20. The second coil layer 22 may be in shape of spiral, e.g., the shape of the second coil layer 22 may be the same as the shape of the first coil layer 21. A material of the second coil layer 22 may be graphene. A thickness of the second coil layer 22 may be about 1 nm to about 50 nm.

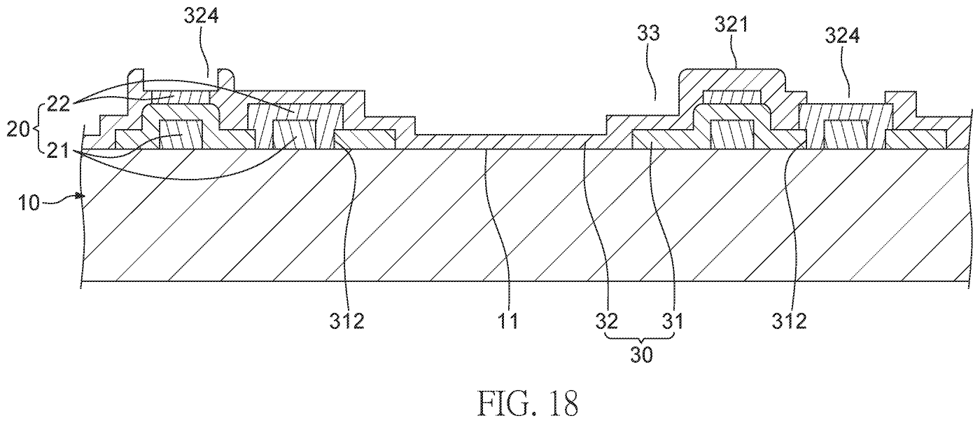

Referring to FIG. 18, a second isolation layer 32 is formed on the second coil layer 22 to cover the second coil layer 22, a portion of the first isolation layer 31 and a portion of the upper surface 11 of the carrier 10. Thus, the first isolation layer 31 and the second isolation layer 32 may constitute an isolation structure 30. In some embodiments, a plurality of openings 324 are formed to extend through the second isolation layer 32 to expose a portion of the second coil layer 22 by, for example, photolithography process (e.g., including exposure and development). A material of the second isolation layer 32 may be, for example, polyimide (PI), epoxy, ajinomoto build-up film (ABF), polybenzoxazole (PBO), Ta₂O₅, SiO₂ or Si₃N₄. A thickness of the second isolation layer 32 may be about 0.2 μm to about 0.8 μm.

In some embodiments, a cavity 33 may be formed to recess from a top surface 321 of the second isolation layer 32.

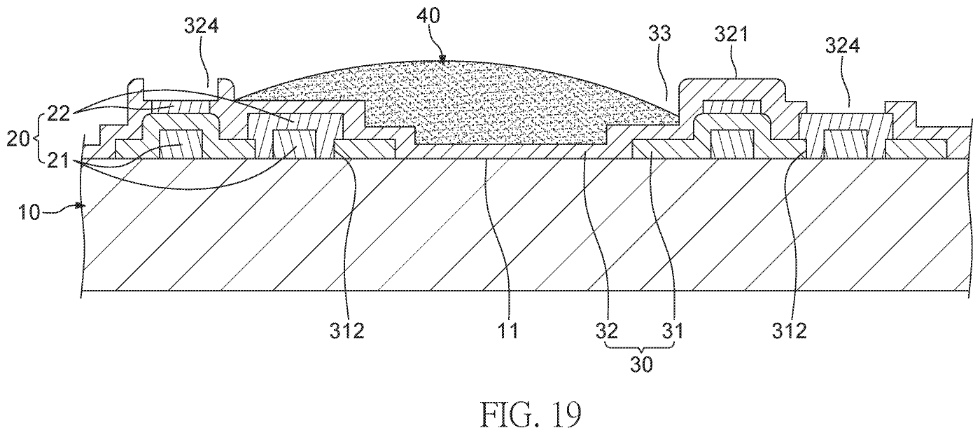

Referring to FIG. 19, a ferromagnetism structure 40 is formed on the second isolation layer 32 of the isolation structure 30 and in the cavity 33. In some embodiments, a ferromagnetism paste may be formed on the second isolation layer 32, and then the ferromagnetism paste may be cured to form the ferromagnetism structure 40. A ferromagnetism material such as mumetal: 18K˜22K (relative magnetic permeability), permeable alloy: 6K˜10K (relative magnetic permeability), furnace steel: 3K˜5K (relative magnetic permeability), steel: 450˜800 (relative magnetic permeability), and Ni: 80˜120 (relative magnetic permeability) may be mixed with binder, solvent and/or polymer filler to form the ferromagnetism paste. A thickness of the ferromagnetism structure 40 may be about 0.5 μm to about 5 μm.

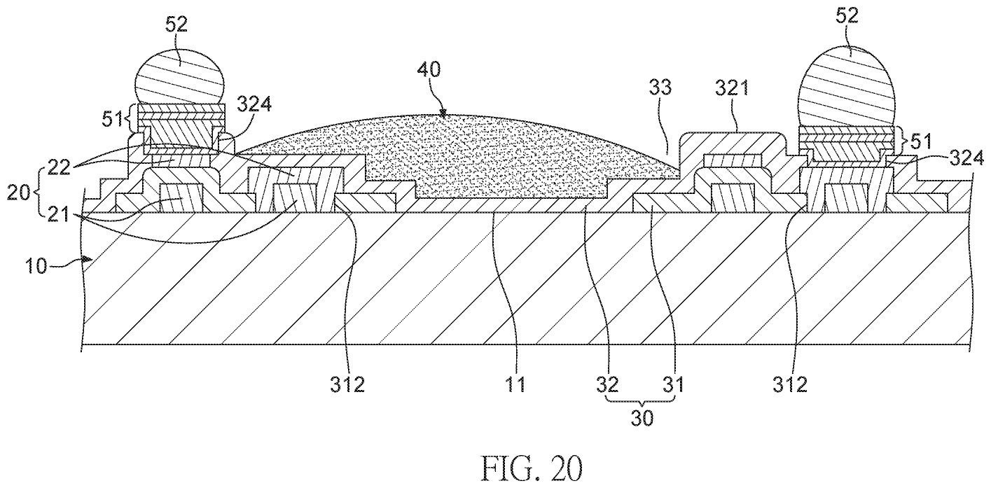

Referring to FIG. 20, a plurality of bumps 51 are formed in the openings 324 of the second isolation layer 32 and on the exposed portion of the second coil layer 22, and then a plurality of external connectors 52 are formed on the bumps 51 for external connection. In some embodiments, each of the bumps 51 may include a metal layer or a plurality of metal layers stacked on one another. The external connectors 52 may be, for example, solder ball or solder bump.

Then, a singulation process is conducted to obtain a plurality of inductor structures 1 of FIG. 1.

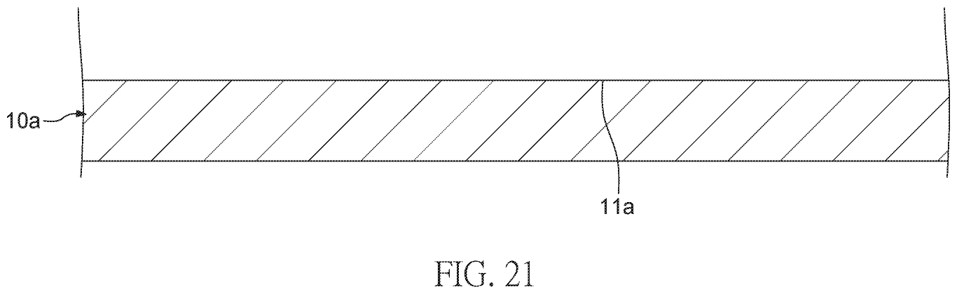

FIG. 21 through FIG. 31 illustrate a method for manufacturing an inductor structure according to some embodiments of the present disclosure. In some embodiments, the method is for manufacturing an inductor structure such as the inductor structure 1c shown in FIG. 5.

Referring to FIG. 21, a base 10a is provided. A material of the base 10a may be, for example, polyimide (PI), epoxy, ajinomoto build-up film (ABF), polybenzoxazole (PBO), Ta₂O₅, SiO₂, Si₃N₄, glass or ceramic. The base 10a has an upper surface 11a. A thickness of the base 10a may be about 20 μm to about 100 μm.

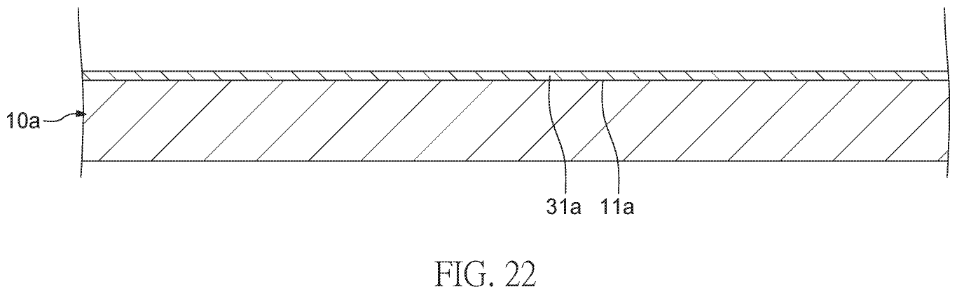

Referring to FIG. 22, a first isolation layer 31a is formed to cover the upper surface 11a of the base 10a. A material of the first isolation layer 31a may be, for example, polyimide (PI), epoxy, ajinomoto build-up film (ABF), polybenzoxazole (PBO), Ta₂O₅, SiO₂ or Si₃N₄. A thickness of the first isolation layer 31a may be about 0.2 μm to about 0.5 μm.

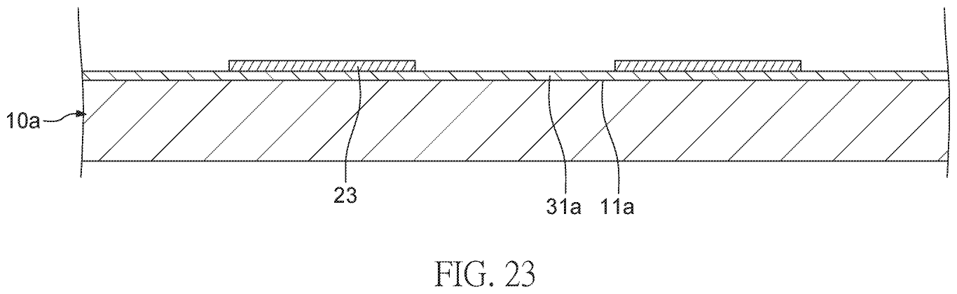

Referring to FIG. 23, at least one inner electrode 23 is formed on the first isolation layer 31a. A material of the inner electrode 23 may be graphene. A thickness of the inner electrode 23 may be about 1 nm to about 5 nm.

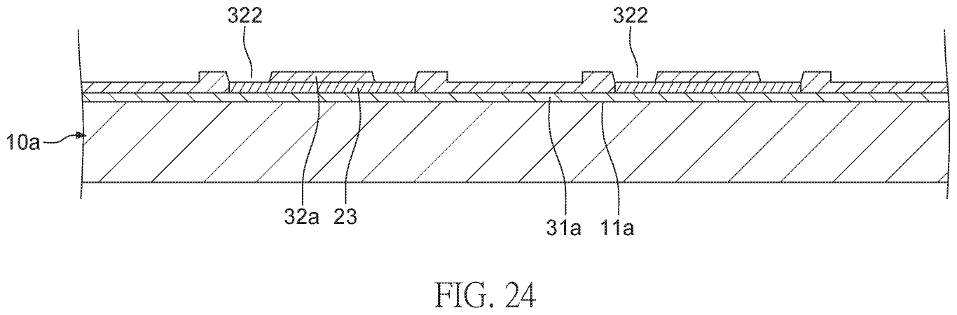

Referring to FIG. 24, a second isolation layer 32a is formed on the first isolation layer 31a and the inner electrode 23 to cover a portion of the first isolation layer 31a and a portion of the inner electrode 23. In some embodiments, a plurality of openings 322 are formed to extend through the second isolation layer 32a to expose a portion of the inner electrode 23 by, for example, photolithography process (e.g., including exposure and development). A material of the second isolation layer 32a may be, for example, polyimide (PI), epoxy, ajinomoto build-up film (ABF), polybenzoxazole (PBO), Ta₂O₅, SiO₂ or Si₃N₄. A thickness of the second isolation layer 32a may be about 0.2 μm to about 0.5 μm.

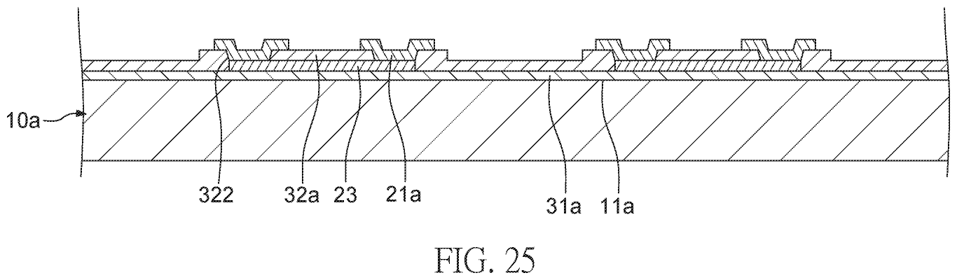

Referring to FIG. 25, a first coil layer 21a is formed in the openings 322 of the second isolation layer 32a and on the inner electrode 23. A material of the first coil layer 21a may be graphene. A thickness of the first coil layer 21a may be about 1 nm to about 5 nm.

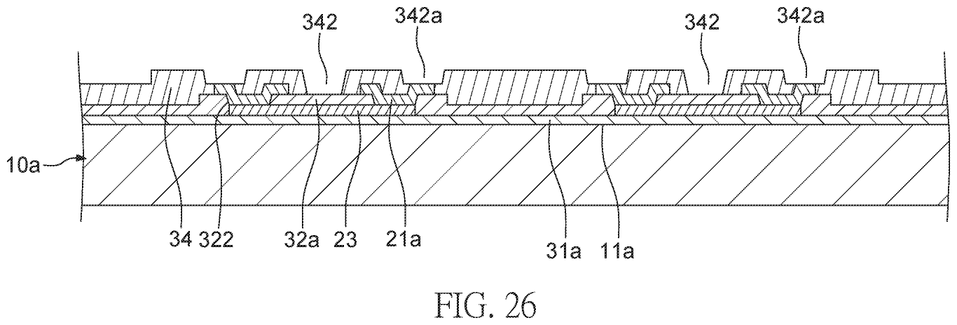

Referring to FIG. 26, a third isolation layer 34 is formed on the second isolation layer 32a to cover the first coil layer 21a. In some embodiments, a plurality of openings 342, 342a are formed to extend through third isolation layer 34 to expose a portion of the second isolation layer 32a (e.g., the openings 342) and a portion of the first coil layer 21a (e.g., the openings 342a) by, for example, photolithography process (e.g., including exposure and development). A material of the third isolation layer 34 may be, for example, polyimide (PI), epoxy, ajinomoto build-up film (ABF), polybenzoxazole (PBO), Ta₂O₅, SiO₂ or Si₃N₄. A thickness of the third isolation layer 34 may be about 0.2 μm to about 0.5 μm.

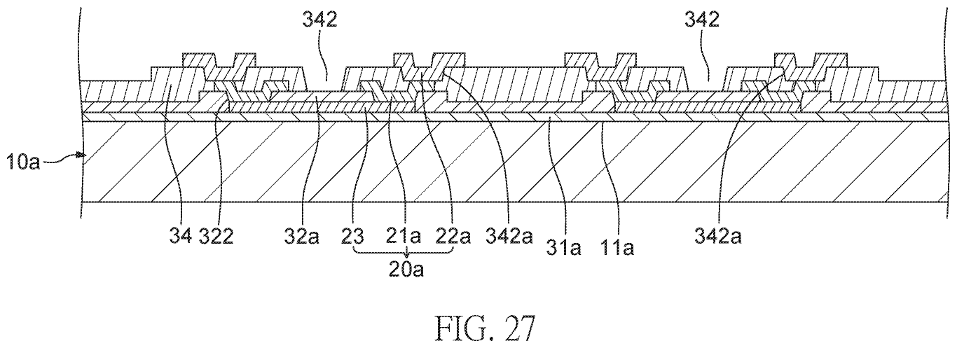

Referring to FIG. 27, a second coil layer 22a is formed in the openings 342a of the third isolation layer 34 and on the first coil layer 21a. Thus, the first coil layer 21a, the second coil layer 22a and the inner electrode 23 may constitute the coil structure 20a. A material of the second coil layer 22a may be graphene. A thickness of the second coil layer 22a may be about 1 nm to about 5 nm.

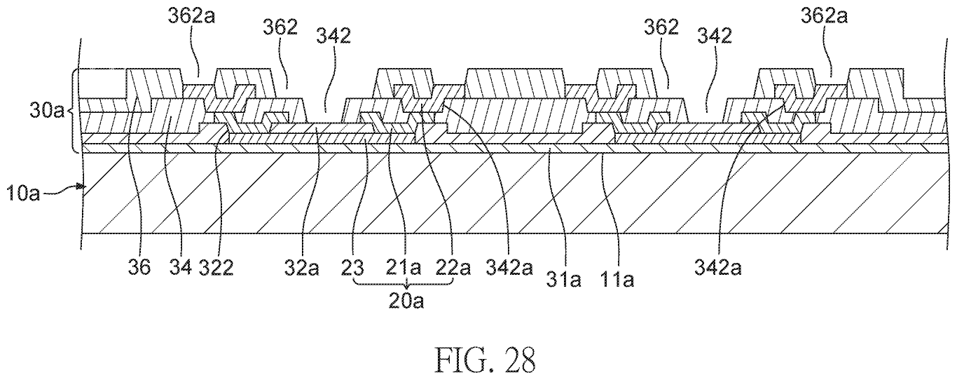

Referring to FIG. 28, a fourth isolation layer 36 is formed on the third isolation layer 34 to cover the second coil layer 22a. Thus, the first isolation layer 31a, the second isolation layer 32a, the third isolation layer 34 and the fourth isolation layer 36 may constitute the isolation structure 30a. In some embodiments, a plurality of openings 362, 362a are formed to extend through fourth isolation layer 36 to expose a portion of the third isolation layer 34 (e.g., the openings 362) and a portion of the second coil layer 22a (e.g., the openings 362a) by, for example, photolithography process (e.g., including exposure and development). A material of the fourth isolation layer 36 may be, for example, polyimide (PI), epoxy, ajinomoto build-up film (ABF), polybenzoxazole (PBO), Ta₂O₅, SiO₂ or Si₃N₄. A thickness of the fourth isolation layer 36 may be about 0.2 μm to about 0.5 μm.

In some embodiments, the opening 362 of the fourth isolation layer 36 may communicate with the opening 342 of the third isolation layer 34. In some embodiments, a size of the opening 362 may be greater than a size of the opening 342.

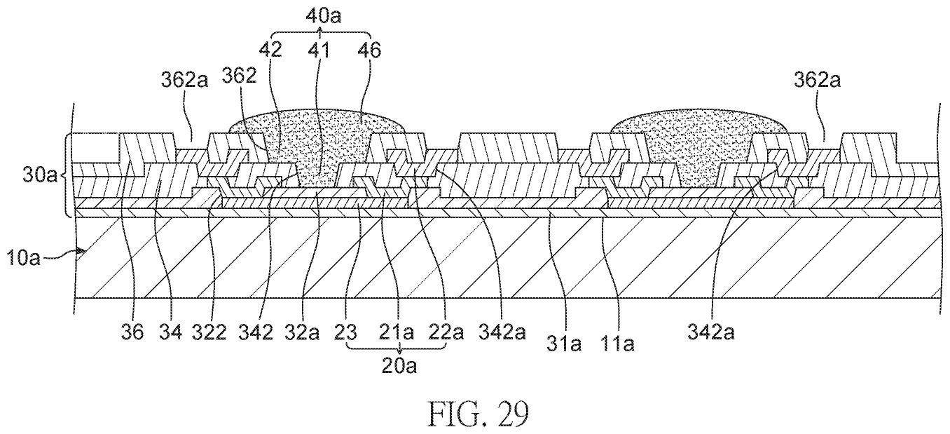

Referring to FIG. 29, at least a ferromagnetism structure 40a is formed in the openings 342 of the third isolation layer 34, in the openings 362 of the fourth isolation layer 36 and on a top surface of the fourth isolation layer 36. In some embodiments, a ferromagnetism paste may be formed in the openings 342 of the third isolation layer 34, in the openings 362 of the fourth isolation layer 36 and on a top surface of the fourth isolation layer 36, and then the ferromagnetism paste may be cured to form the ferromagnetism structure 40a. A ferromagnetism material such as mumetal: 18K˜22K (relative magnetic permeability), permeable alloy: 6K˜10K (relative magnetic permeability), furnace steel: 3K˜5K (relative magnetic permeability), steel: 450˜800 (relative magnetic permeability), and Ni: 80˜120 (relative magnetic permeability) may be mixed with binder, solvent and/or polymer filler to form the ferromagnetism paste.

In some embodiments, the ferromagnetism structure 40a may have a cross-section in a mushrooms-shape. The ferromagnetism structure 40a may include a first taper portion 41, a second taper portion 42 and a protruding portion 46. The first taper portion 41 may be formed on the exposed portion of the second isolation layer 32a and in the opening 342 of the third isolation layer 34. In some embodiments, the first taper portion 41 may extend through the third isolation layer 34. In addition, the first taper portion 41 may taper downward.

The second taper portion 42 may be formed on the first taper portion 41 and in the opening 362 of the fourth isolation layer 36. In some embodiments, the second taper portion 42 may extend through the fourth isolation layer 36. In addition, the second taper portion 42 may taper downward.

The protruding portion 46 may be formed on the second taper portion 42 and the top surface of the fourth isolation layer 36.

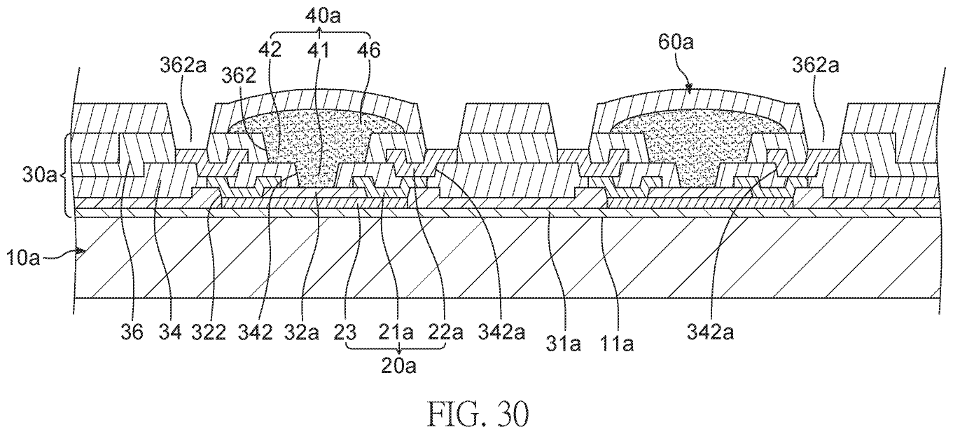

Referring to FIG. 30, a protection layer 60a is formed on the fourth isolation layer 36 of the isolation structure 30a to cover the ferromagnetism structure 40a.

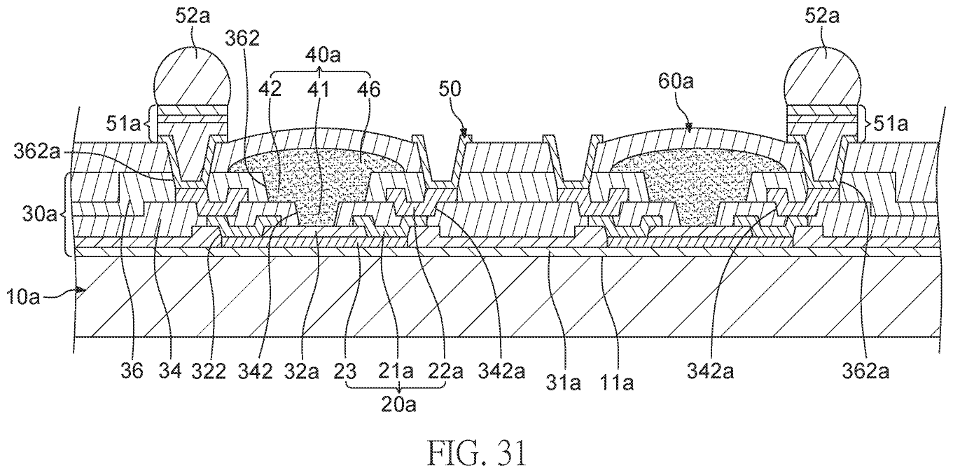

Referring to FIG. 31, at least one via structure 50 is formed to extend through the protection layer 60a and the fourth isolation layer 36 and on the exposed portion of the second coil layer 22a, a plurality of bumps 51a are formed to extend through the protection layer 60a, in the openings 362a of the fourth isolation layer 36 and on the exposed portion of the second coil layer 22a, and then a plurality of external connectors 52a are formed on the bumps 51a for external connection. In some embodiments, each of the bumps 51a may include a metal layer or a plurality of metal layers stacked on one another. The external connectors 52a may be, for example, solder ball or solder bump.

Then, a singulation process is conducted to obtain a plurality of inductor structures 1c of FIG. 5.

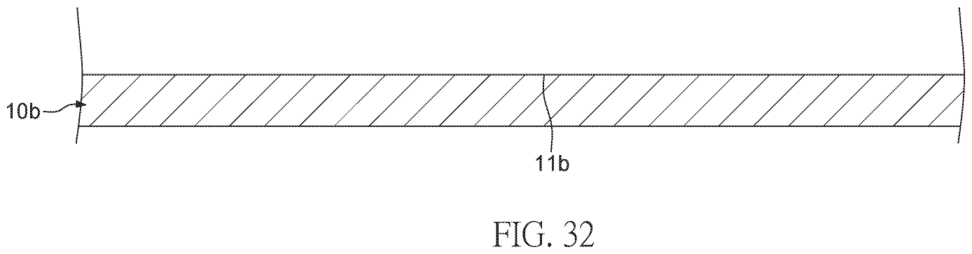

FIG. 32 through FIG. 43 illustrate a method for manufacturing an inductor structure according to some embodiments of the present disclosure. In some embodiments, the method is for manufacturing an inductor structure such as the inductor structure 1g shown in FIG. 10.

Referring to FIG. 32, a base 10b is provided. A material of the base 10b may be, for example, polyimide (PI), epoxy, ajinomoto build-up film (ABF), polybenzoxazole (PBO), Ta₂O₅, SiO₂, Si₃N₄, glass or ceramic. The base 10b has an upper surface 11b. A thickness of the base 10b may be about 5 μm to about 50 μm.

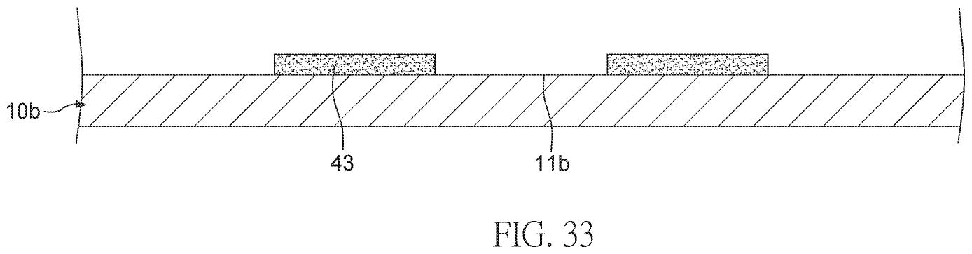

Referring to FIG. 33, a lower portion 43 of a ferromagnetism structure 40b (FIG. 10) is formed on the upper surface 11b of the base 10b. A material of the lower portion 43 may be, for example, NdFeB, SmCo₅ or Sm₂Co₁₇.

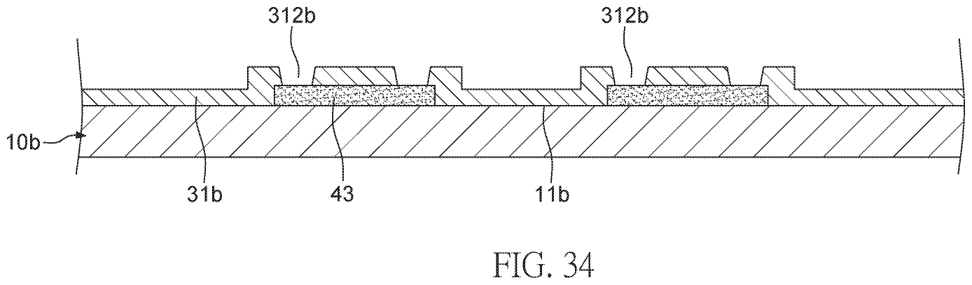

Referring to FIG. 34, a first isolation layer 31b is formed on the upper surface 11b of the base 10b to cover a portion of the upper surface 11b and a portion of the lower portion 43. In some embodiments, a plurality of openings 312b are formed to extend through the first isolation layer 31b to expose a portion of the lower portion 43 by, for example, photolithography process (e.g., including exposure and development). A material of the first isolation layer 31b may be, for example, polyimide (PI), epoxy, ajinomoto build-up film (ABF), polybenzoxazole (PBO), Ta₂O₅, SiO₂ or Si₃N₄. A thickness of the first isolation layer 31b may be about 0.2 μm to about 0.5 μm.

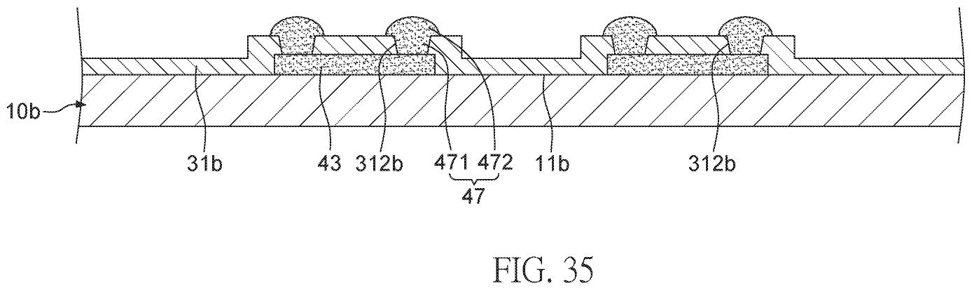

Referring to FIG. 35, a plurality of first vias 47 are formed in the openings 312b of the first isolation layer 31b and on the exposed portion of the lower portion 43. In some embodiments, the first via 47 may be in a mushrooms-shape. The first via 47 may include a taper portion 471 and a protruding portion 472. The taper portion 471 may be formed in the opening 312b of the first isolation layer 31b and on the exposed portion of the lower portion 43. In some embodiments, the taper portion 471 may taper downward. The protruding portion 472 may be formed on the taper portion 471 and the first isolation layer 31b. In some embodiments, the protruding portion 472 may be in a curved-shape.

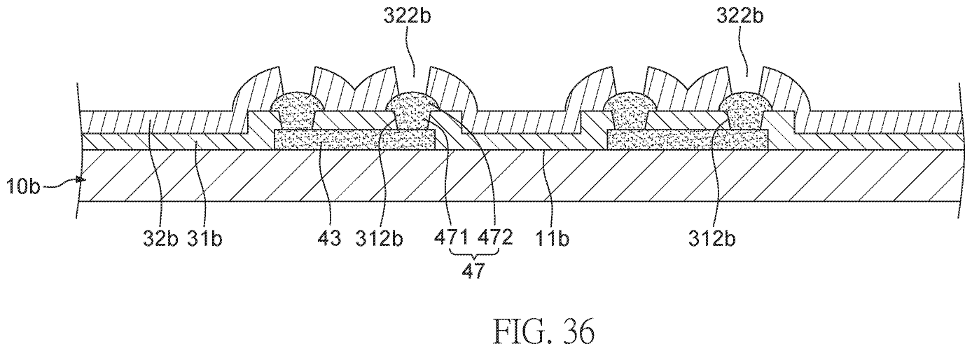

Referring to FIG. 36, a second isolation layer 32b is formed on the first isolation layer 31b to cover a portion of each of the first vias 47. In some embodiments, a plurality of openings 322b are formed to extend through the second isolation layer 32b to expose a portion (e.g., a portion of the protruding portion 472) of each of the first vias 47. A material of the second isolation layer 32b may be, for example, polyimide (PI), epoxy, ajinomoto build-up film (ABF), polybenzoxazole (PBO), Ta₂O₅, SiO₂ or Si₃N₄. A thickness of the second isolation layer 32b may be about 0.2 μm to about 0.5 μm.

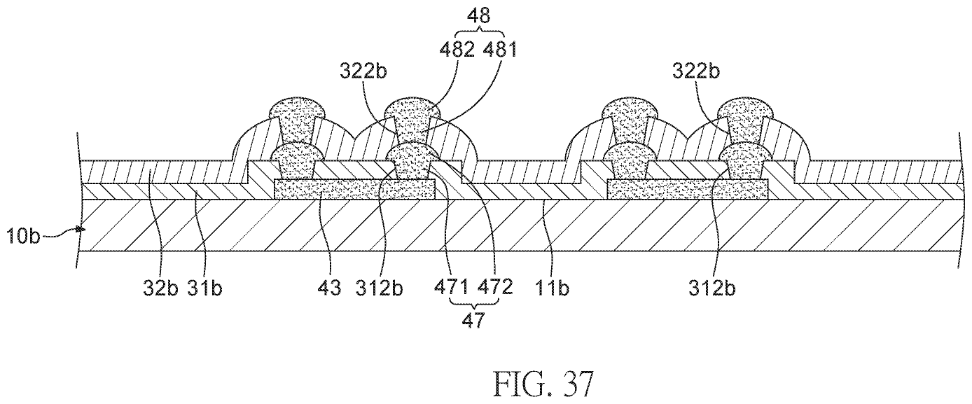

Referring to FIG. 37, a plurality of second vias 48 are formed in the openings 322b of the second isolation layer 32b and on the exposed portions (e.g., the exposed portions of the protruding portions 472) of the first vias 47. In some embodiments, the second via 48 may be in a mushrooms-shape. The second via 48 may include a taper portion 481 and a protruding portion 482. The taper portion 481 may be formed in the opening 322b of the second isolation layer 32b and on the protruding portion 472 of the first via 47. In some embodiments, the taper portion 481 may taper downward. The protruding portion 482 may be formed on the taper portion 481 and the second isolation layer 32b. In some embodiments, the protruding portion 482 may be in a curved-shape.

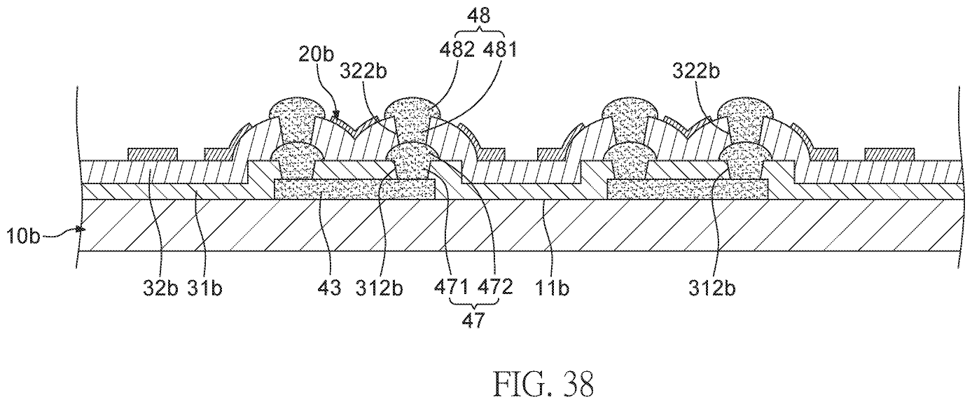

Referring to FIG. 38, a coil structure 20b is formed on the second isolation layer 32b. The coil structure 20b may be, for example, series coil. A material of the coil structure 20b may include, for example, graphene, Au, Ag, Cu, Al, Ni or alloy. A thickness of the coil structure 20b may be about 1 nm to about 5 nm.

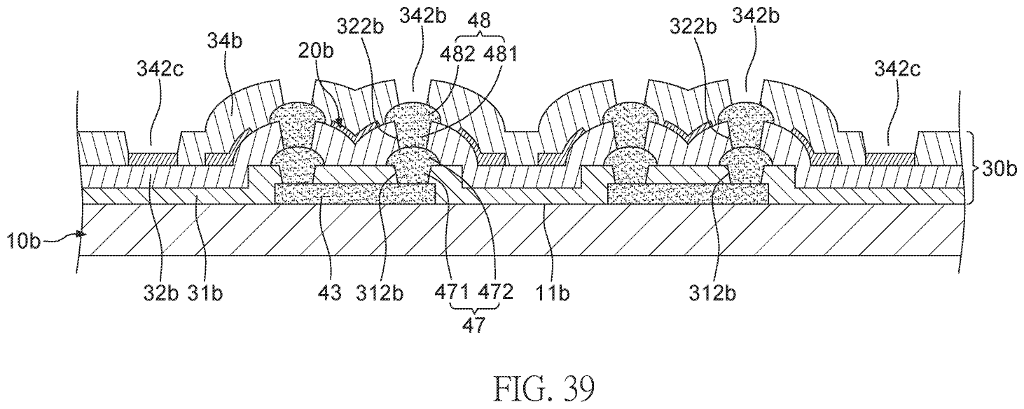

Referring to FIG. 39, a third isolation layer 34b is formed on the second isolation layer 32a to cover a portion of the coil structure 20b and a portion of each of the second vias 48. Thus, the first isolation layer 31b, the second isolation layer 32b and the third isolation layer 34b may constitute the isolation structure 30b. In some embodiments, a plurality of openings 342b, 342c are formed to extend through the third isolation layer 34b to expose a portion of the coil structure 20b (e.g., the openings 342c) and a portion (e.g., a portion of the protruding portion 482) of each of the second vias 48 (e.g., the openings 342b). A material of the third isolation layer 34b may be, for example, polyimide (PI), epoxy, ajinomoto build-up film (ABF), polybenzoxazole (PBO), Ta₂O₅, SiO₂ or Si₃N₄. A thickness of the third isolation layer 34b may be about 0.2 μm to about 0.5 μm.

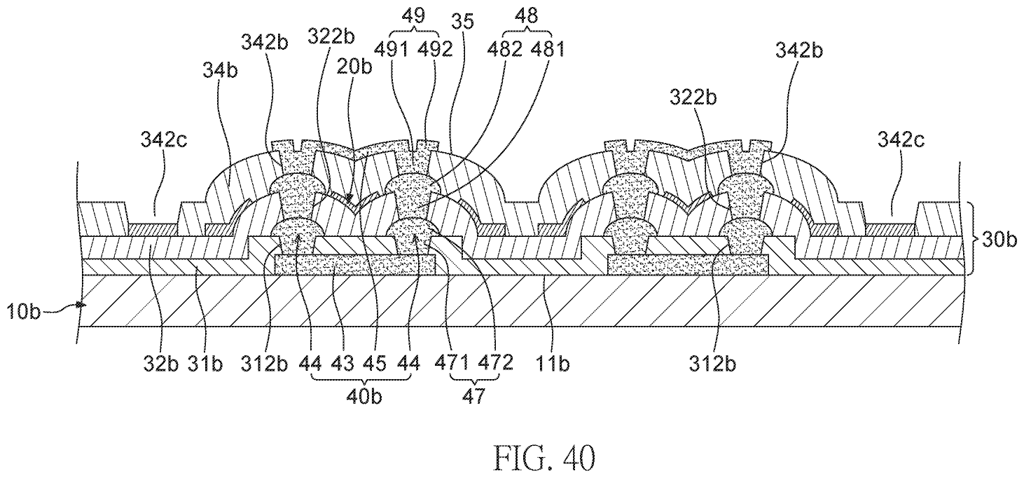

Referring to FIG. 40, a plurality of third vias 49 are formed in the openings 342b of the third isolation layer 34b and on the exposed portions (e.g., the exposed portions of the protruding portions 482) of the second vias 48, and an upper portion 45 of the ferromagnetism structure 40b (FIG. 10) is formed on the third isolation layer 34b of the isolation structure 30b. Thus, the first vias 47, the second via 48s and the third vias 49 may constitute a plurality of via portions 44 of the ferromagnetism structure 40b (FIG. 10). Then, the lower portion 43, the via portions 44 and the upper portion 45 may constitute the ferromagnetism structure 40b. In some embodiments, the third vias 49 and the upper portion 45 may be formed concurrently.

In some embodiments, the third via 49 may be in a mushrooms-shape. The third via 49 may include a taper portion 491 and a protruding portion 492. The taper portion 491 may be formed in the opening 342b of the third isolation layer 34b and on the protruding portion 482 of the second via 48. In some embodiments, the taper portion 491 may taper downward. The protruding portion 492 may be formed on the taper portion 491 and the third isolation layer 34b. In some embodiments, the protruding portion 492 may be in a curved-shape.

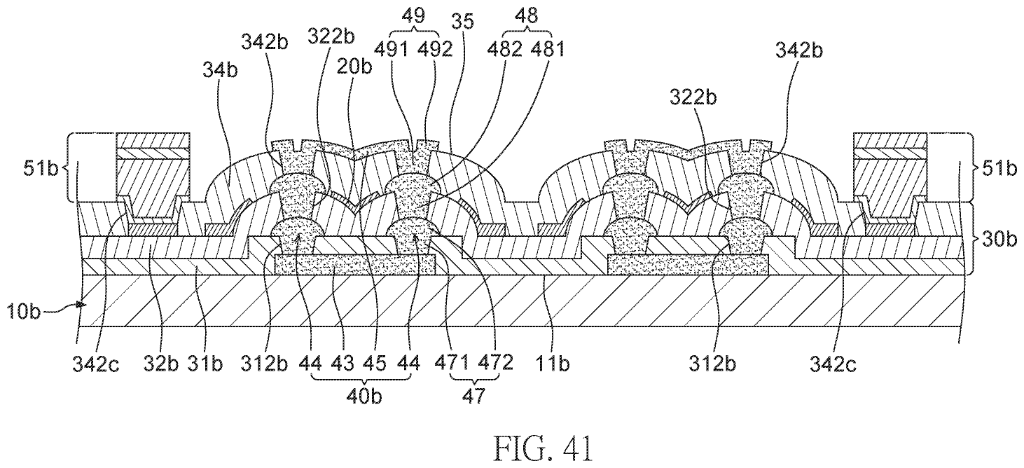

Referring to FIG. 41, a plurality of bumps 51b are formed in the openings 342c of the third isolation layer 34b and on the exposed portion of the coil structure 20b. In some embodiments, each of the bumps 51b may include a metal layer or a plurality of metal layers stacked on one another.

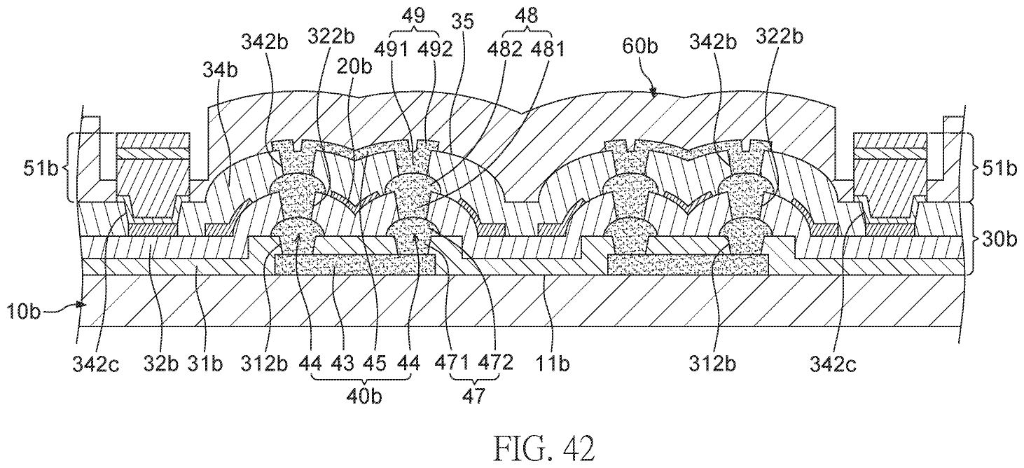

Referring to FIG. 42, a protection layer 60b is formed on the third isolation layer 34b of the isolation structure 30b to cover the via portions 44 (e.g., the protruding portions 492 of the third vias 49) and the upper portion 45 of the ferromagnetism structure 40b.

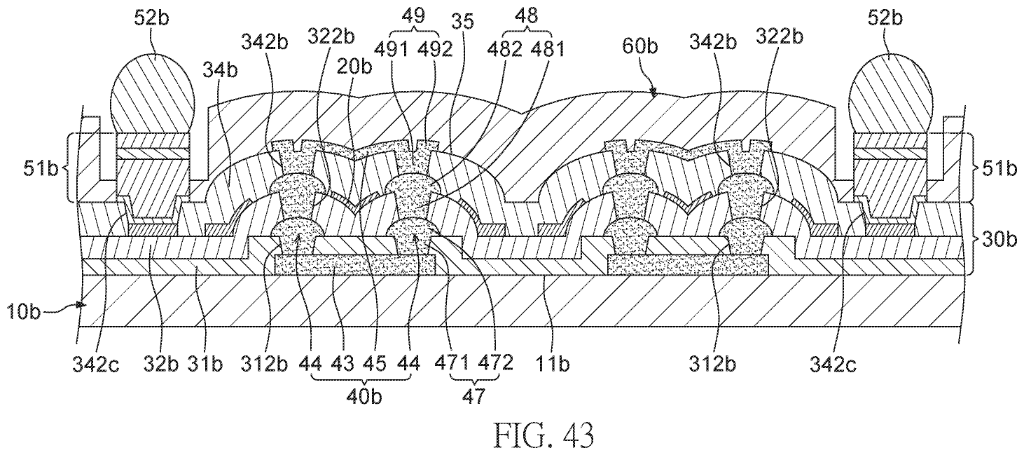

Referring to FIG. 43, a plurality of external connectors 52b are formed on the bumps 51b for external connection. The external connectors 52b may be, for example, solder ball or solder bump.

Then, a singulation process is conducted to obtain a plurality of inductor structures 1g of FIG. 10.

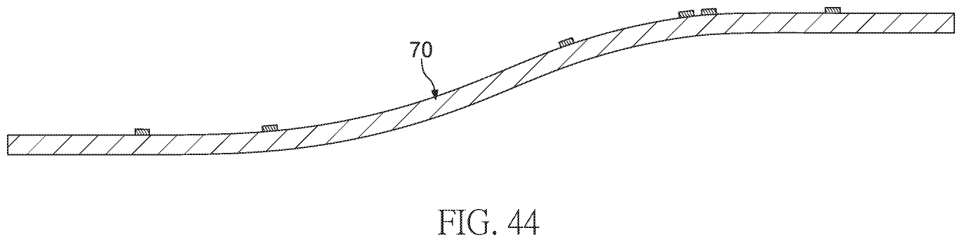

FIG. 44 illustrates a method for manufacturing an inductor structure according to some embodiments of the present disclosure. In some embodiments, the method is for manufacturing an inductor structure such as the inductor structure 1i shown in FIG. 13. The initial several stages of the illustrated process are the same as, or similar to, the stages illustrated in FIG. 32 through FIG. 43. FIG. 44 depicts a stage subsequent to that depicted in FIG. 43.

Referring to FIG. 44, a flexible substrate 70 is provided. Then, the inductor structure 1g of FIG. 10 is electrically connected to the flexible substrate 70 through the external connectors 52b, so as to obtain the inductor structure 1i of FIG. 13.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be substantially flat if a displacement between a highest point and a lowest point of the surface is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 10⁴ S/m, such as at least 10⁵ S/m or at least 10⁶ S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An inductor structure, comprising:
a carrier having an upper surface;
a coil structure disposed adjacent to the upper surface of the carrier;
an isolation structure covering the upper surface and the coil structure; and
a ferromagnetism structure disposed on the isolation structure.

2. The inductor structure of claim 1, wherein the coil structure surrounds the ferromagnetism structure.

3. The inductor structure of claim 1, wherein a material of the coil structure includes graphene.

4. The inductor structure of claim 1, wherein the isolation structure defines a cavity, and the ferromagnetism structure is disposed in the cavity.

5. The inductor structure of claim 1, wherein the isolation structure includes a first isolation layer covering a portion of the coil structure and a second isolation layer covering the first isolation layer and a portion of the upper surface, and the ferromagnetism structure is disposed on the second isolation layer.

6. The inductor structure of claim 5, wherein the coil structure includes a first coil layer disposed on the upper surface and a second coil layer covering a portion of the first coil layer, and the second isolation layer covers a portion of the second coil layer.

7. The inductor structure of claim 6, wherein a portion of the first isolation layer is disposed between the first coil layer and the second coil layer.

8. The inductor structure of claim 6, wherein the first isolation layer defines a plurality of openings extending through the first isolation layer to expose a portion of the first coil layer.

9. The inductor structure of claim 8, wherein a portion of the second coil layer extends into the openings and covers a portion of the upper surface.

10. An inductor structure, comprising:
a base having an upper surface;
an isolation structure disposed adjacent to the upper surface of the base;
a coil structure embedded in the isolation structure; and
at least a ferromagnetism structure disposed around a portion of the coil structure.

11. The inductor structure of claim 10, wherein the isolation structure includes a first isolation layer covering the upper surface of the base, and the coil structure includes at least one inner electrode disposed on the first isolation layer.

12. The inductor structure of claim 11, wherein the ferromagnetism structure corresponds to the inner electrode.

13. The inductor structure of claim 11, wherein the isolation structure further includes a second isolation layer disposed on the first isolation layer, and a portion of the second isolation layer is disposed between the ferromagnetism structure and the inner electrode.

14. The inductor structure of claim 11, wherein the isolation structure further includes a second isolation layer disposed on the first isolation layer, and the coil structure further includes a first coil layer extending through the second isolation layer and electrically connected to the inner electrode.

15. The inductor structure of claim 11, wherein the isolation structure further includes a second isolation layer disposed on the first isolation layer, and the ferromagnetism structure includes a first taper portion disposed on the second isolation layer.

16. The inductor structure of claim 15, wherein the isolation structure further includes a third isolation layer disposed on the second isolation layer, and the first taper portion extends through the third isolation layer.

17. The inductor structure of claim 15, wherein the ferromagnetism structure further includes a protruding portion disposed on and connected to the first taper portion.

18. The inductor structure of claim 10, wherein the ferromagnetism structure includes a lower portion disposed on the upper surface of the base, and the isolation structure covers a portion of the lower portion of the ferromagnetism structure.

19. The inductor structure of claim 18, wherein the ferromagnetism structure further includes a plurality of via portions extending through the isolation structure and connected to the lower portion.

20. The inductor structure of claim 19, wherein the ferromagnetism structure further includes an upper portion disposed on the isolation structure and connected to the via portions.
